(19) United States
(12) Patent Application Publication
(10) Pub. No.: US 2017/0324549 A1
(43) Pub. Date: Nov. 9, 2017

(54) SECURED TIME OF FLIGHT MEASUREMENT

(71) Applicants: Benny Abramovsky, Petah Tikva (IL); Gaby Prechner, Rishon Lezion (IL); Elad Eyal, SHOHAM (IL)

(72) Inventors: Benny Abramovsky, Petah Tikva (IL); Gaby Prechner, Rishon Lezion (IL); Elad Eyal, SHOHAM (IL)

(21) Appl. No.: 15/276,543

(22) Filed: Sep. 26, 2016

Related U.S. Application Data
(60) Provisional application No. 62/332,560, filed on May 6, 2016.

(51) Int. Cl. H04L 9/08; H04W 12/08; H04L 9/14

(52) U.S. Cl. CPC H04L 9/0816; H04L 9/14; H04W 12/08

(57) ABSTRACT

Computing readable media, apparatuses, and methods for secure time of flight measurements are disclosed. An apparatus comprising processing circuitry is disclosed. The processing circuitry configured to encode a fine time measurement (FTM) request. The processing circuitry further configured to decode a FTM response from the responder, where the FTM response is to be received at the wireless device at a time t2, and generate a symmetric key from a private encryption key of the wireless device and the public encryption key of the responder. The processing circuitry further configured to transmit an acknowledgement to the FTM response, the acknowledgement is transmitted at time t3, and decode an encrypted FTM frame from the responder with the symmetric key, the decrypted FTM message comprising a time t1 when the FTM response was to be transmitted and a time t4 when the acknowledgement to the FTM response was to be received.

### PRIORITY CLAIM

This application claims the benefit of priority under 35 USC 119(e) to U.S. Provisional Patent Application Ser. No. 62/332,560, filed May 6, 2016, which is incorporated herein by reference in its entirety.

### TECHNICAL FIELD

Embodiments pertain to wireless networks and wireless communications. Some embodiments relate to wireless local area networks (WLANs) and Wi-Fi networks including networks operating in accordance with the IEEE 802.11 family of standards. Some embodiments relate to IEEE 802.11ax/mc. Some embodiments relate to methods, computer readable media, and apparatus for secured time of flight measurements. Some embodiments relate to fine timing measurements (FTM) that are secured.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates a method of FTM in accordance with some embodiments;

FIG. 3 illustrates a STA performing multiple FTMs and an adversary 300 in accordance with some embodiments;

FIG. 4 illustrates a method of secured FTM in accordance with some embodiments;

FIG. 5 illustrates a FTM request frame in accordance with some embodiments;

FIG. 6 illustrates a public key subelement in accordance with some embodiments;

FIG. 7 illustrates a FTM frame in accordance with some embodiments;

FIG. 8 illustrates a frame control field in accordance with some embodiments;

FIG. 9 illustrates a method for secured time of flight measurement in accordance with some embodiments;

FIG. 10 illustrates a method for secured time of flight measurement in accordance with some embodiments; and

FIG. 11 illustrates a block diagram of an example machine up on which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

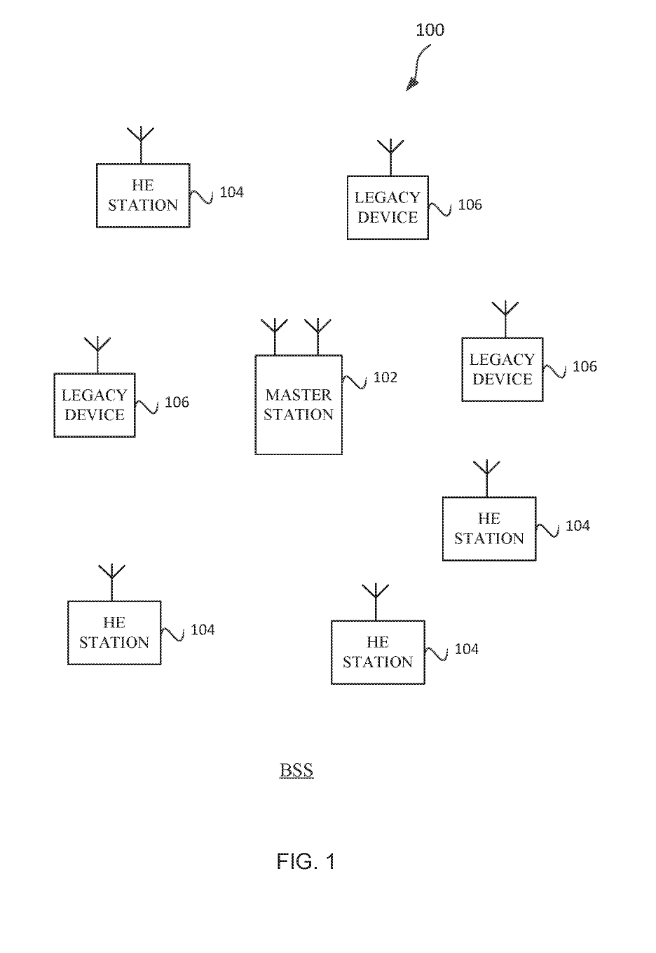

FIG. 1 illustrates a WLAN 100 in accordance with some embodiments. The WLAN 100 may comprise a basis service set (BSS) 100 that may include a master station 102, which may be an AP, a plurality of high-efficiency wireless (e.g., IEEE 802.11ax) (HE) stations 104, and a plurality of legacy (e.g., IEEE 802.1 in/ac) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one master station 102 that is part of an extended service set (ESS). A controller (not illustrated) may store information that is common to the more than one master stations 102.

The legacy devices 106 may operate in accordance with one or more of IEEE 802.11 a/b/g/n/ac/ad/af/ah/aj/ay, or another legacy wireless communication standard. The legacy devices 106 may be STAs or IEEE STAs. The HE STAs 104 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE STAs 104 may be termed high efficiency (HE) stations.

The master station 102 may communicate with legacy devices 106 in accordance with legacy IEEE 802.11 communication techniques. In example embodiments, the master station 102 may also be configured to communicate with HE STAs 104 in accordance with legacy IEEE 802.11 communication techniques.

In some embodiments, a HE frame may be configurable to have the same bandwidth as a channel. The HE frame may be a physical Layer Convergence Procedure (PLCP) Protocol Data Unit (PPDU).

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

A HE frame may be configured for transmitting a number of spatial streams, which may be in accordance with MU-MIMO and may be in accordance with OFDMA. In other embodiments, the master station 102, HE STA 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11 embodiments, e.g, IEEE 802.11ax embodiments, a master station 102 may operate as a master station which may be arranged to contend for a wireless medium (e.g., during a contention period) to receive exclusive control of the medium for an HE control period. In some embodiments, the HE control period may be termed a transmission opportunity (TXOP). The master station 102 may transmit a HE master-sync transmission, which may be a trigger frame or HE control and schedule transmission, at the beginning of the HE control period. The master station 102 may transmit a time duration of the TXOP and sub-channel information. During the HE control period, HE STAs 104 may communicate with the master station 102 in accordance with a non-contention based multiple access technique such as OFDMA or MU-MIMO. This is unlike conventional WLAN communications in which devices communicate in accordance with a contention-based communication technique, rather than a multiple access technique. During the HE control period, the master station 102 may communicate with HE stations 104 using one or more HE frames. During the HE control period, the HE STAs 104 may operate on a sub-channel smaller than the operating range of the master station 102. During the HE control period, legacy stations refrain from communicating. The legacy stations may need to receive the communication from the master station 102 to defer from communicating.

In accordance with some embodiments, during the TXOP the HE STAs 104 may contend for the wireless medium with the legacy devices 106 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The master station 102 may also communicate with legacy stations 106 and/or HE stations 104 in accordance with legacy IEEE 802.11 communication techniques. In some embodiments, the master station 102 may also be configurable to communicate with HE stations 104 outside the HE TXOP in accordance with legacy IEEE 802.11 communication techniques, although this is not a requirement.

In some embodiments the HE station 104 may be a “group owner” (GO) for peer-to-peer modes of operation. A wireless device may be a HE station 102 or a master station 102.

In some embodiments, the HE station 104 and/or master station 102 may be configured to operate in accordance with IEEE 802.11mc.

In example embodiments, the HE station 104 and/or the master station 102 are configured to perform the methods and functions described herein in conjunction with FIGS. 1-11.

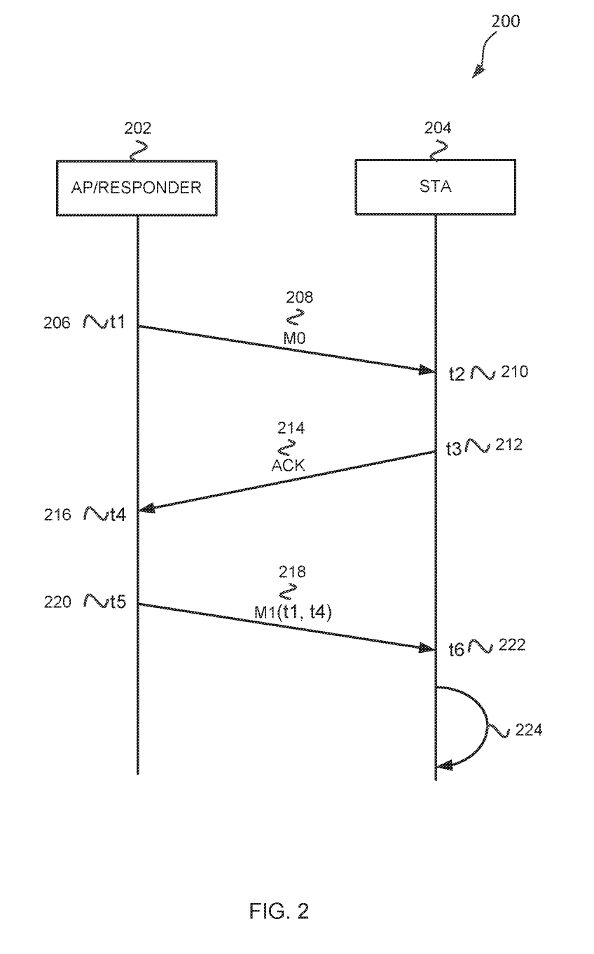

FIG. 2 illustrates a method 200 of FTM in accordance with some embodiments. Illustrated in FIG. 2 is AP/Responder 202 and STA 204. The AP/responder 202 may be a master station 102 or a HE station 104. The STA 204 may be a master station 102 or a HE station 104. The method 200 begins at time t1 206 with the AP/responder 202 transmitting a message MO 208 to the STA 204. The AP/responder 202 may record time t1 206. The message MO 208 may be a FTM response. Prior to time t1 the STA 204 may have transmitted a FTM request to the AP/responder 202. The STA 204 may receive the message MO 208 at time t2 210. The STA 204 may record the time t2 210.

The method 200 continues at time t3 212 with the STA 204 transmitting an acknowledgment (ACK) 214 to the AP/responder 202. The ACK 214 may be received by the AP/responder 202 at time t4 216. The STA 204 may record the time t3 212. The AP/responder 202 may record time t4 216.

The method 200 continues at time t5 220 with the AP/responder 202 transmitting message m1 (t1,t4) 218. The message m1 comprises time t1 206 and time t4 216. The message m1 (t1, t4) 218 may be received at time t6 222 by the STA 204.

The method 200 continues at operation 224 with the STA 204 determining a distance from AP/responder 202. The STA 204 may determine the distance based on equation (1): round trip time (RTT)=(t4−t1)−(t3−t2). The STA 204 may perform the FTM method 200 with one or more additional AP/responders 202. In some embodiments, the values of time t1 206 and time t4 216 are transmitted over the wireless medium unencrypted.

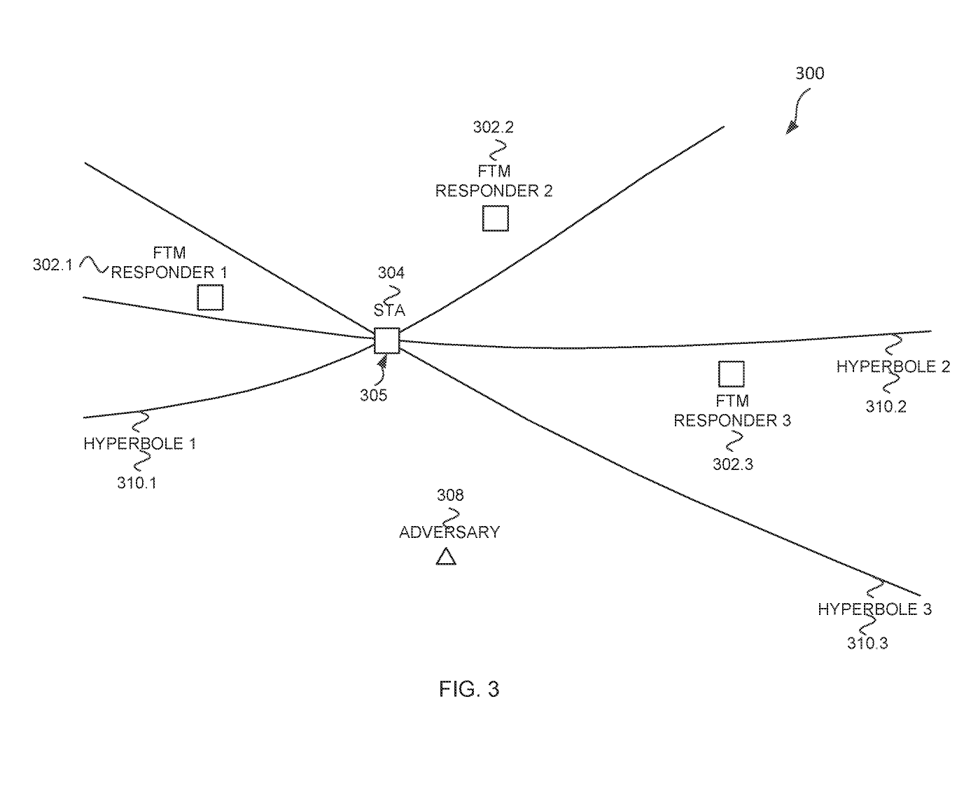

FIG. 3 illustrates a STA performing multiple FTMs and an adversary 300 in accordance with some embodiments. Illustrated in FIG. 3 is FTM responders 302, STA 304, hyperboles 310, and adversary 308. Each of STA 304, FTM responders 302, and adversary 308 may be either a master station 102 or HE station 104.

The STA 304 may have performed three FTMs with FTM responder 1 302.1, FTM responder 2 302.2, and FTM responder 3 302.3. The adversary 308 may determine from the FTM between the STA 304 and the FTM responder 302.1 that the STA 304 is on hyperbole 310.1. The adversary 308 may determine from the FTM between the STA 304 and the FTM responder 302.2 that the STA 304 is on hyperbole 310.2. The adversary 308 may determine from the FTM between the STA 304 and the FTM responder 302.3 that the STA 304 is on hyperbole 310.3.

The adversary 308 can determine the location of the STA 304 at location 305 based on intercepting the three FTMs between STA 304 and the three FTM responders 302. The time-tags transmitted in the packets may be unencrypted enabling the adversary 308 to determine the location of the STA 304.

The adversary 308 may passively intercept the three FTMs between STA 304 and the three FTM responders 302. In some embodiments, the adversary 308 may be an active and trigger an attack to falsely modify the position which the STA 304 calculates. For example, the adversary 308 may respond as if it is one of the FTM responders 302. The user of the STA 304 may have comprised security because of the adversary 308 learning of the location of the STA 304.

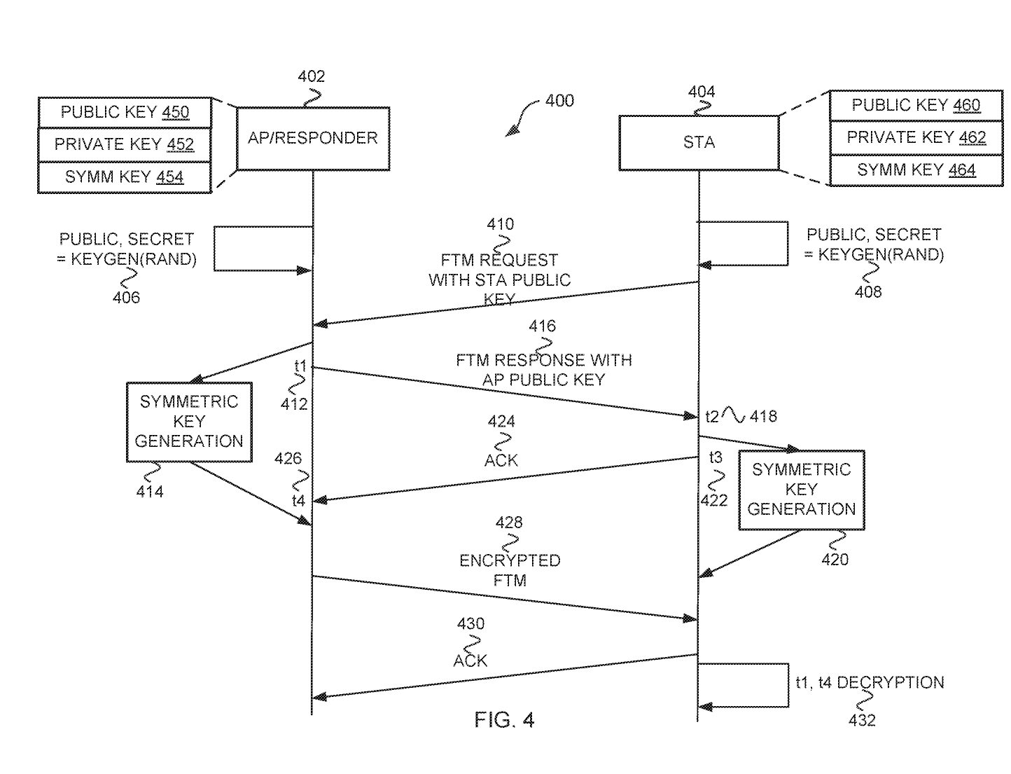

FIG. 4 illustrates a method 400 of secured FTM in accordance with some embodiments. Illustrated in FIG. 4 is AP/responder 402 and STA 404. Each of AP/responder 402 and STA 404 may be master station 102 or HE station 104. The AP/responder 402 comprises a public key 450, private key 452, and symmetric (symm) key 454. The STA 404 comprises a public key 460, private key 462, and symm key 464.

The method 400 optionally begins at operation 406 with the AP/responder 402 generating a public key 450 and a secret or private key 452, which may be based on a random number. In some embodiments, the AP/responder 402 may have already generated a public key 450 and a private key 452 and stored the keys. The method 400 optionally continues at operation 408 with the STA 404 generating a public key 460 and a secret or private key 462, which may be based on a random number.

The method 400 continues with the STA 404 transmitting FTM request with STA public key 410, e.g. public key 4060. For example, FTM request with STA public key 410 may be the same or similar as FTM request frame 500, which may include public key subelement 514. The public key 460 of STA 404 may be a public key subelement 600.

The method 400 continues with symmetric key generation 414 by the AP/responder 402, symm key 454. Symmetric key generation 414 may be performed in parallel to performing other operations, e.g. transmitting FTM response with AP public key 416. The AP/responder 402 may use Elliptic Curve Diffie-Hellman method to generate the symmetric key 454. The symmetric key 454 may be based on the public key 460 of STA 404 and the secret key or private key 452 of AP/responder 402. The symmetric key 454 generation 414 may be time consuming relative to the time that packets 410, 416, 424, 428, and 430 can be encoded, transmitted, and decoded. The AP/responder 402 may store the symm key 454 with an identification of the STA 404 such as an association identification (AID).

In some embodiments, a public key crypto-system may be used such as N-th Degree Truncated Polynomial Ring (NTRU) or Rivest, Shamir, and Adelman (RSA) rather than Elliptic curve Diffie-Hellman (ECDH).

The method 400 continues with the AP/responder 402 transmitting FTM response with AP public key (e.g., 450) 416. The AP/responder 402 may record time t1 412 when FTM response with AP public key 416 is transmitted by the AP/responder 402. FTM response with AP public key 416 may be an FTM frame 700 with the public key (e.g., 450) of AP/responder 402 being a public key subelement 726.

The method 400 continues with STA 404 receiving FTM response with AP public key 416 at time t2 418. STA 404 may store the t2 418.

The method 400 continues with symmetric key generation 420 by the STA 404. The symmetric key generation 420 may be performed in parallel to other operations performed by STA 404. The symmetric key generation 420 may use the public key 450 of the AP/responder and the private key 462 of the STA 404 to generate the symmetric key 454. The symmetric key 454 may be used to decrypt data encrypted by symmetric key 454.

The method 400 continues with the STA 404 transmitting acknowledgement (ACK) 424 at time t3 422. STA 404 may store the time t3 422.

The method 400 continues with AP/Responder 402 receiving ACK 424 at time t4 426. The AP/Responder 402 may store time t4 426.

The method 400 continues with the AP/Responder 402 transmitting encrypted FTM 428. The symmetric key generation 414 is completed before the AP/Responder 402 transmits the encrypted FTM 428. The AP/responder 402 encrypts the encrypted FTM 428 with the symmetric key 454. The AP/responder 402 may encrypt a media access control (MAC) portion of the encrypted FTM 428. The AP/responder 402 may set a field of a frame control field (e.g., 800) of encrypted FTM 428 that indicates that encrypted FTM 428 is encrypted, e.g., a protected frame 802 field of a frame control field 800.

The encrypted FTM 428 may be a FTM frame 700 with a frame control field 800 with a protected frame 802 field indicating that the FTM frame 700 is encrypted. The encrypted FTM 428 includes TI 412 and T4 426.

The method 400 continues with the STA 404 receiving encrypted FTM 428. The STA 404 needs to complete symmetric key 464 generation 420 to decrypt encrypted FTM 428.

The method 400 continues with STA 404 transmitting an ACK 430 to AP/Responder 402. The AP/responder 402 may receive the ACK 430 and determine that encrypted FTM 428 was received by STA 404.

The method 400 continues with t1, t4 decryption 432. STA 404 decrypts encrypted FTM 428 with t1 412 and t4 426 using symmetric key 464. STA 404 now has t1 412, t2 418, t3 422, and t4 426 to determine a distance from AP/responder 402.

In some embodiments, STA 404 receives the public key 450 of the AP/responder 402 in a beacon from the AP/responder 402. In some embodiments, STA 404 receives the public key 450 of the AP/responder 402 in a different packet, e.g. from another AP/responder or a central server. The symmetric key generation 420 may begin at any time after the STA 404 generates a public key 460 and a private key 452 for the STA 404 and receives the public key 450 of the AP/responder 402.

The AP/responder 402 and/or the STA 404 may store the symmetric key 450, 460, respectively, for use in another communication with one another.

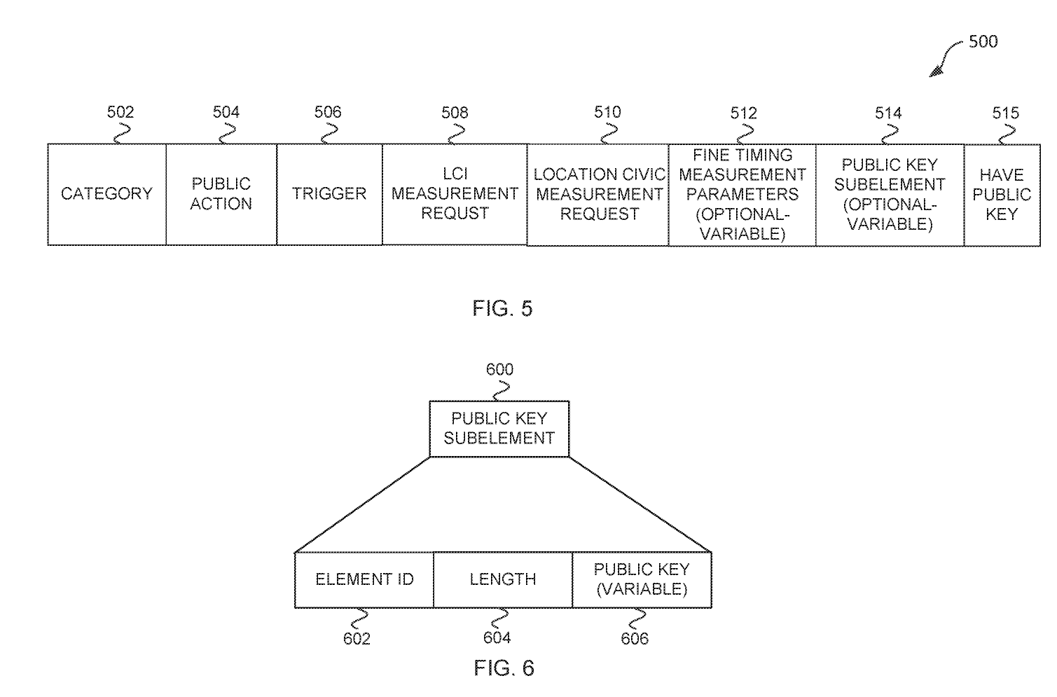

In some embodiments, the FTM request with STA public key 410 may include a field that indicates that the STA 404 already has the public key of the AP/responder 402, e.g. have public key 515 of FIG. 5. The AP/responder 402 may determine not to transmit the public key 450 in FTM response with AP public key 416 if the STA 404 indicates it already has the public key 450 of the AP/Responder 402.

In some embodiments, the AP/responder 402 may already have the public key 460 of the STA 404. For example, the AP/responder 402 may receive the public key 460 of the STA 404 from another AP or a central server.

In some embodiments, the STA 404 and/or AP/responder 402 may use optimized elliptical curve libraries to determine the symmetric keys 464, 454, respectively. In some embodiments, the symmetric key 464, 454, respectively, may be generated by the STA 404 and/or AP/responder 402 in 20 ms.

The encrypted FTM 428 may only be decrypted using the symmetric key 464. The symmetric key 454 can only be generated with the public key 460 of STA 404 and private key 452 of AP/Responder 402, or with public key 450 of AP/responder 402 and private key 462 of STA 404. So, only the STA 404 and the AP/responder 402 can decrypt encrypted FTM 428. The location of STA 404 may be keep confidential by encrypting the encrypted FTM 428. In some embodiments, a different set of messages may be exchanged to determine the location of the STA 404, but in each case, timing from the AP/Responder 402 is encrypted and transmitted to the STA 404 to enable the STA 404 to confidentially determine the location of the STA 404. For example, time of flight (ToF) may be equal to ((t4−t1)−(t3−t2))/2, and the distance from AP/responder 402 and STA 404 may be (ToF/2) times speed of light. The STA 404 can then determine the range from the AP/responder 402 and use triangulation with a other AP/responders 402 to determine a location. In some embodiments, the times t1 412, t2 418, t3 422, and t4 426 may be determined differently. For example, one or more of FTM response with AP public key 416, ACK 424, and encrypted FTM 428 may be a different type of packet type. Moreover, in some embodiments, the AP/responder 402 may initiate the ToF method with the STA 404.

FIG. 5 illustrates a FTM request frame 500 in accordance with some embodiments. The FTM request frame 500 includes category 502, public action 504, trigger 506, location configuration information (LCI) measurement request 508, location civic measurement request 510, FTM parameters 512, public key sub-element 514, and have public key 515.

The category 502 may be set to a value indicating a FTM action frame. The public action 504 may be 32 to indicate it is a FTM request. The trigger 506 may be set to 1 indicates that the initiating STA requests that the responding STA start or continue sending Fine Timing Measurement frames. The Trigger field set to 0 indicates that the initiating STA requests that the responding STA stop sending Fine Timing Measurement frames. The LCI measurement request 508 is optional and if present contains a measurement request element that indicates parameters for a report. The location civic measurement request 510 is optional, and, if present, contains a measurement request element. The FTM parameters 512 is present in the initial FTM request frame. If present, it contains FTM parameters element. The public key sub-element 514 is optional, and, if present, may be the same or similar as 600 of FIG. 6. Have public key 515 may indicate whether or not the transmitting wireless device already has the public key 515 of the receiving wireless device.

FIG. 6 illustrates a public key subelement 600 in accordance with some embodiments. The public key subelement 600 may include an element identification (ID) 602, which may identify the element as public key sub-element, length 604, which may be a length of the public key 606, and public key 606, which may be variable in length. In some embodiments, the public key subelement 600 may have different fields.

In some embodiments one or more of the fields may not be present. Additionally, in some embodiments, one or more additional fields may be present.

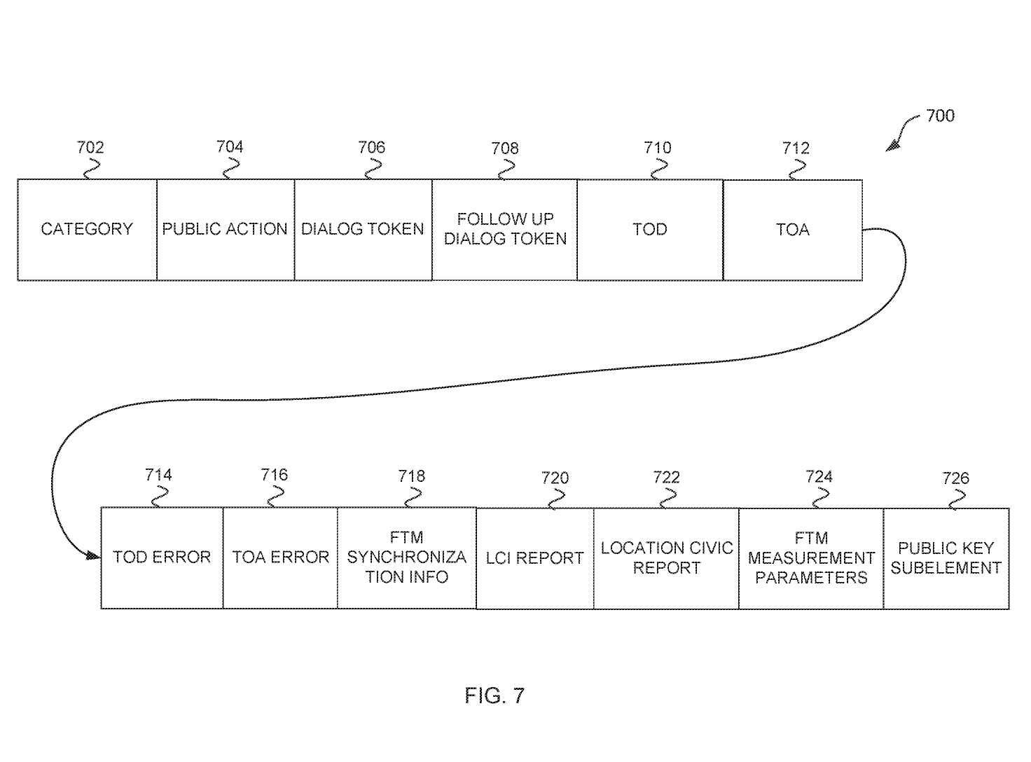

FIG. 7 illustrates a FTM frame 700 in accordance with some embodiments. The FTM frame 700 may include one or more of the following fields. A category 702, a public action 704, a dialog token 706, a follow up dialog token 708, time of department (TOD) 710, time of arrival (TOA) 712, TOD error 714, TOA error 716, FTM synchronization information 718, LCI report 720, location civic report 722, fine timing measurement parameters 724, public key subelement 726.

The category 702 may be set to a value indicating a FTM action frame. The public action 504 may indicate it is a FTM measure frame. Dialog token 706 is a token chosen by the responding STA to identify the FTM frame as the first of a pair of frames. Follow up dialog token 708 is token to indicate it is a follow up to the FTM frame. TOD 710 time of department. TOA 712 time of arrival. TOD error 714 indicates error parameters. TOA error 716 indicates error parameters. FTM synchronization information 718 may include a FTM synchronization information element. LCI report 720 may be a location configuration information measurement report. Location civic report 722 is a measurement report element. FTM parameters 724 may be parameters for FTM measurements.

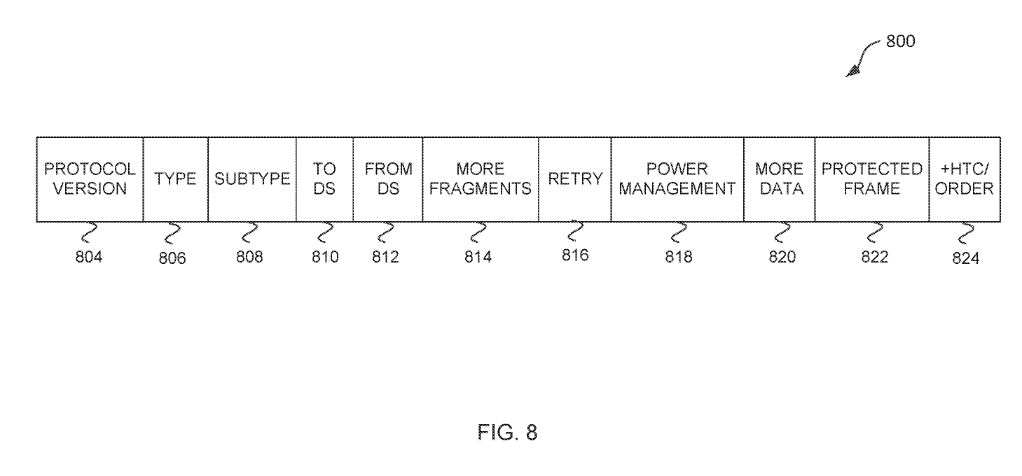

FIG. 8 illustrates a frame control field 800 in accordance with some embodiments. FIG. 8 illustrates frame control field 800 which may be a frame control field for FTM frame 700 and/or FTM request frame 500. The frame control field 800 includes a protected frame 822, which may be one bit and indicates whether the FTM message is encrypted. In some embodiments, the frame control field 800 includes one or more of the following fields: protocol version 804, type 806, subtype 808, to distribution system (DS) 810, from DS 812, more fragments 814, retry 816, power management 818, more data 820, protected frame 822, and +HTC order 824. The following describes embodiments of the frame control field 800. The protocol version 804 may indicate a protocol version. The type 806 and subtype 808 may identify the function of the frame. To DS 810 and from DS 812 may indicate source and destination of a frame. More fragments 814 may indicate if there are additional media access control fragments in a next frame. Retry 816 indicates that the frame is a retransmission. The power management subfield 818 is used to indicate a power management mode of a station. The more data 820 subfield may indicate more data or that a station is power save mode. The +HTC/order 824 subfield may indicate a type of service class. In some embodiments, the frame control field 800 may be in accordance with one or more communication protocols such as IEEE 802.11mc.

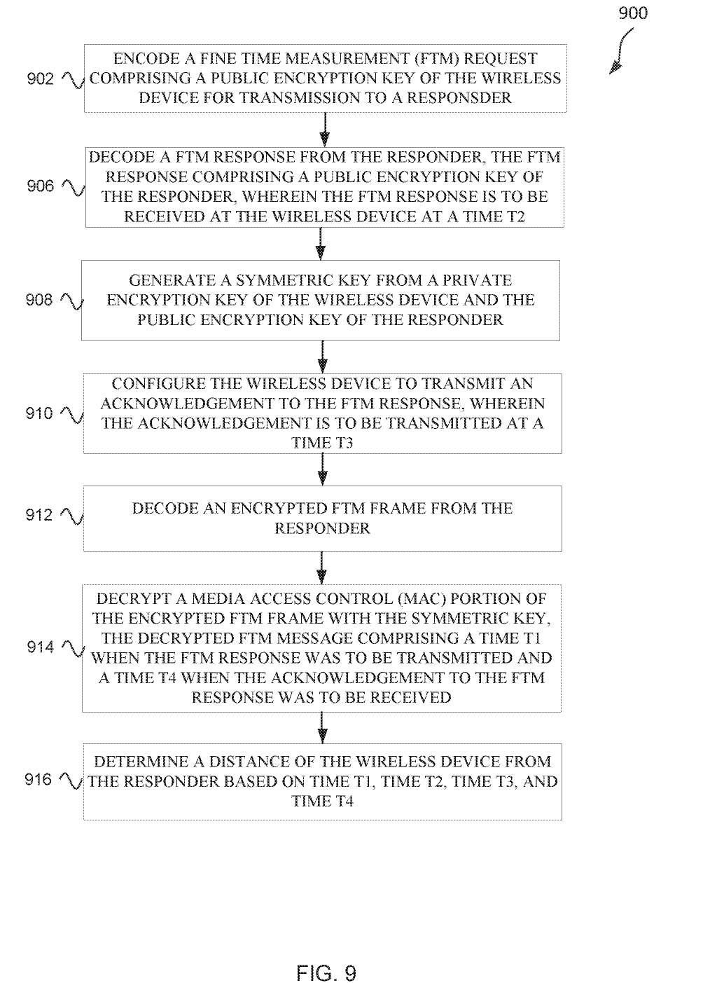

FIG. 9 illustrates a method 900 for secured time of flight measurement in accordance with some embodiments. The method 900 begins at operation 902 with encode a fine time measurement (FTM) request comprising a public encryption key of the wireless device for transmission to a responder. For example, STA 404 may encode FTM request with STA public key 410.

Optionally, the method 900 includes operation with configuring the wireless device to transmit the FTM request to a responder. For example, an apparatus of STA 404 may configure the STA 404 to transmit the FTM request with STA public key 410.

The method 900 continues at operation 906 with decoding a FTM response from the responder, the FTM response comprising a public encryption key of the responder, wherein the FTM response is to be received at the wireless device at a time t2. For example, STA 404 may receive FTM response with AP public key 416 from AP/responder 402 with public key 450.

The method 900 continues at operation 908 with generating a symmetric key from a private encryption key of the wireless device and the public encryption key of the responder. For example, STA 404 may generate symmetric key 464.

The method 900 continues at operation 910 with configuring the wireless device to transmit an acknowledgement to the FTM response, wherein the acknowledgement is to be transmitted at a time t3. For example, an apparatus of STA 404 may configure STA 404 to transmit ACK 424 at time t3.

The method 900 continues at operation 912 with decoding an encrypted FTM frame from the responder. For example, STA 404 may decode encrypted FTM 428 from AP/Responder 402.

The method 900 continues at operation 914 with decrypting a MAC portion of the encrypted FTM frame with the symmetric key, the decrypted FTM message comprising a time t1 when the FTM response was to be transmitted and a time t4 when the acknowledgement to the FTM response was to be received. For example, STA 404 may decrypt encrypted FTM 428 which comprises times t1 412 and t4 426.

The method 900 continues at operation 916 with determining a distance of the wireless device from the responder based on time t1, time t2, time t3, and time t4. For example, STA 404 may use the times t1 412, t2 418, t3 422, and t4 426 to determine a distance from AP/responder 402 to the STA 404.

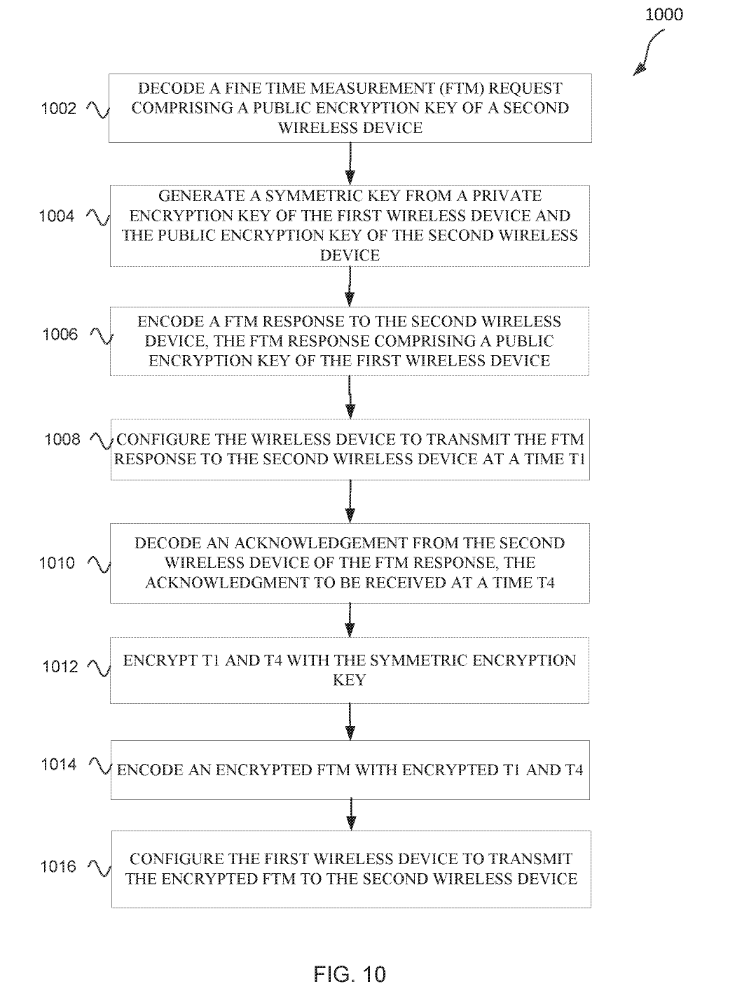

FIG. 10 illustrates a method 1000 for secured time of flight measurement in accordance with some embodiments. The method 1000 begins at operation 1002 with decoding a FTM request comprising a public encryption key of a second wireless device. For example, AP/responder 402 may decode FTM request with STA public key 410, which may include public key 460 of STA 404.

The method 1000 continues at operation 1004 with generating a symmetric key from a private encryption key of the first wireless device and the public encryption key of the second wireless device. For example, AP/responder 402 may generate symmetric key 454 with private key 452 and public key 460.

The method 1000 continues at operation 1006 with encoding a FTM response to the second wireless device, the FTM response comprising a public encryption key of the first wireless device. For example, AP/responder 402 may encode FTM response with AP public key 416, which may include public key 450.

The method 1000 continues at operation 1008 with configuring the wireless device to transmit the FTM response to the second wireless device at a time t1. For example, an apparatus of the AP/responder 402 may configure the AP/responder 402 to transmit FTM response with AP public key 416.

The method 1000 continues at operation 1010 with decoding an acknowledgement from the second wireless device of the FTM response, the acknowledgment to be received at a time t4. For example, AP/responder 402 may decode ACK 424 received at time t4 426.

The method 1000 continues at operation 1012 with encrypting t1 and t4 with the symmetric encryption key. For example, AP/responder 402 may encrypt t1 412 and t4 426 with symmetric key 454.

The method 1000 continues at operation 1014 with encoding an encrypted FTM with encrypted t1 and t4. For example, AP/responder 402 may encode encrypted FTM 428.

The method 1000 continues at operation 1016 with configuring the first wireless device to transmit the encrypted FTM to the second wireless device. For example, an apparatus of AP/responder 402 may configure the AP/responder 402 to transmit the encrypted FTM 428.

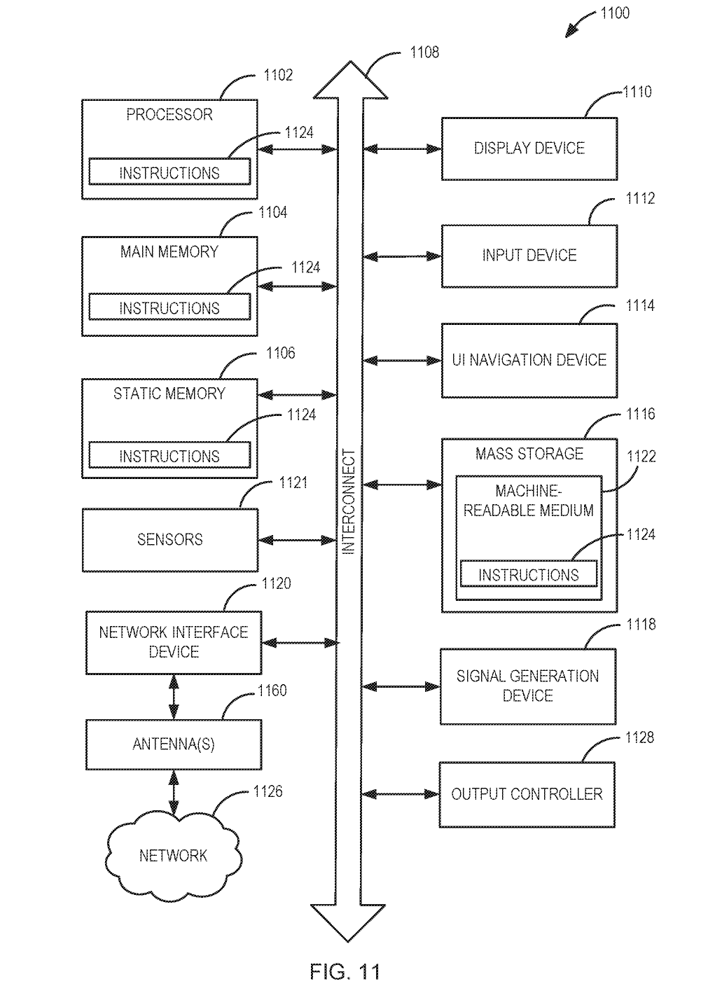

FIG. 11 illustrates a block diagram of an example machine 1100 up on which any one or more of the techniques (e.g., methodologies) discussed herein may perform. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a master station 102, HE station 104, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display device 1110, an input device 1112 (e.g., a keyboard), and a user interface (UI) navigation device 1114 (e.g., a mouse). In an example, the display device 1110, input device 1112 and UI navigation device 1114 may be a touch screen display. The machine 1100 may additionally include a mass storage (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 1102 and/or instructions 1124 may comprise processing circuitry and/or transceiver circuitry.

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine readable media.

While the machine readable medium 1122 is illustrated as a single medium, the term “machine readable medium” may include a single medium or multiple media (e.g., a centralized or distributed database, and/or associated caches and servers) configured to store the one or more instructions 1124.

An apparatus of the machine 1100 may be one or more of a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108.

The term “machine readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1120 may include one or more physical jacks (e.g., Ethernet, coaxial, or phone jacks) or one or more antennas to connect to the communications network 1126. In an example, the network interface device 1120 may include one or more antennas 1160 to wirelessly communicate using at least one of single-input multiple-output (SIMO), multiple-input multiple-output (MIMO), or multiple-input single-output (MISO) techniques. In some examples, the network interface device 1120 may wirelessly communicate using Multiple User MIMO techniques. The term “transmission medium” shall be taken to include any intangible medium that is capable of storing, encoding or carrying instructions for execution by the machine 1100, and includes digital or analog communications signals or other intangible medium to facilitate communication of such software.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

Example 1 is an apparatus of a wireless device including: memory; and processing circuitry coupled to the memory, the processing circuitry configured to: encode a fine time measurement (FTM) request including a public encryption key of the wireless device for transmission to a responder; decode a FTM response from the responder, the FTM response including a public encryption key of the responder, where the FTM response is received at the wireless device at a time t2; generate a symmetric key from a private encryption key of the wireless device and the public encryption key of the responder; configure the wireless device to transmit an acknowledgement to the FTM response, where the acknowledgement is to be transmitted at a time t3; decode an encrypted FTM frame from the responder; decrypt a media access control (MAC) portion of the encrypted FTM frame with the symmetric key, the decrypted FTM message including a time t1 when the FTM response was transmitted and a time t4 when the acknowledgement to the FTM response was received; and determine a distance of the wireless device from the responder based on time t1, time t2, time t3, and time t4.

In Example 2, the subject matter of Example 1 optionally includes where the processing circuitry is configured to: generate the public encryption key of the wireless device and the private encryption key.

In Example 3, the subject matter of any one or more of Examples 1-2 optionally include where the processing circuitry is configured to: begin generating the symmetric key from the private encryption key of the wireless device and the public encryption key of the responder after time t2 and complete generating the symmetric key from the private encryption key of the wireless device and the public encryption key of the responder after the time t3.

In Example 4, the subject matter of Example 3 optionally includes where the processing circuitry is configured to generate the symmetric key using an Elliptic Curve Diffie-Hellman method or a public key crypto-system.

In Example 5, the subject matter of any one or more of Examples 3-4 optionally include where the processing circuitry is configured to generate the symmetric key in a parallel process.

In Example 6, the subject matter of any one or more of Examples 1-5 optionally include where the processing circuitry is configured to: configure the wireless device to transmit an acknowledgement of the encrypted FTM message.

In Example 7, the subject matter of any one or more of Examples 1-6 optionally include where the processing circuitry is configured to: perform a second FTM measurement with the responder using the symmetric key.

In Example 8, the subject matter of any one or more of Examples 1-7 optionally include where the processing circuitry is further configured to: configure the wireless device to transmit the FTM request to the responder in accordance with one or both of orthogonal frequency division multiple-access (OFDMA) and multiple-user multiple-input and multiple-output (MU-MIMO).

In Example 9, the subject matter of any one or more of Examples 1-8 optionally include where the processing circuitry is configured to: decode the FTM response from the responder, where the public key of the responder is a part of a subelement, the subelement including an subelement identification, a length, and the public key, where the subelement identification identifies the subelement as a public key subelement.

In Example 10, the subject matter of any one or more of Examples 1-9 optionally include where the processing circuitry is configured to: encode the FTM request including a subelement, the subelement including a subelement identification, a length, and the public key of the wireless device, where the subelement identification identifies the subelement as a public key subelement.

In Example 11, the subject matter of any one or more of Examples 1-10 optionally include where the processing circuitry is configured to: decode the encrypted FTM frame from the responder, where a protected frame bit of a frame control field indicates the MAC portion of the encrypted FTM frame is encrypted.

In Example 12, the subject matter of any one or more of Examples 1-11 optionally include where the wireless device and the one or more stations are each one from the following group: an Institute of Electrical and Electronic Engineers (IEEE) 802.11ax access point, an IEEE 802.11ax station, an IEEE 802.11mc station, an IEEE 802.11mc access point, an IEEE 802.11 station, and an IEEE 802.11 access point.

In Example 13, the subject matter of any one or more of Examples 1-12 optionally include transceiver circuitry coupled to the processing circuitry.

In Example 14, the subject matter of Example 13 optionally includes one or more antennas coupled to the transceiver circuitry.

Example 15 is a non-transitory computer-readable storage medium that stores instructions for execution by one or more processors, the instructions to configure the one or more processors to cause an apparatus of a wireless device to: encode a fine time measurement (FTM) request including a public encryption key of the wireless device for transmission to a responder; decode a FTM response from the responder, the FTM response including a public encryption key of the responder, where the FTM response is received at the wireless device at a time t2; generate a symmetric key from a private encryption key of the wireless device and the public encryption key of the responder; configure the wireless device to transmit an acknowledgement to the FTM response, where the acknowledgement is to be transmitted at a time t3; decode an encrypted FTM frame from the responder; decrypt a media access control (MAC) portion of the encrypted FTM frame with the symmetric key, the decrypted FTM message including a time t1 when the FTM response was transmitted and a time t4 when the acknowledgement to the FTM response was received; and determine a distance of the wireless device from the responder based on time t1, time t2, time t3, and time t4.

In Example 16, the subject matter of Example 15 optionally includes the instructions to further configure the one or more processors to cause the apparatus to: begin generating the symmetric key from the private encryption key of the wireless device and the public encryption key of the responder after time t2 and complete generating the symmetric key from the private encryption key of the wireless device and the public encryption key of the responder after the time t3.

In Example 17, the subject matter of any one or more of Examples 15-16 optionally include the instructions to further configure the one or more processors to cause the apparatus to: generate the symmetric key using an Elliptic Curve Diffie-Hellman method or a public key crypto-system.

Example 18 is a method performed by an apparatus of a wireless device, the method including: encoding a fine time measurement (FTM) request including a public encryption key of the wireless device for transmission to a responder; decoding a FTM response from the responder, the FTM response including a public encryption key of the responder, where the FTM response is received at the wireless device at a time t2: generating a symmetric key from a private encryption key of the wireless device and the public encryption key of the responder; configuring the wireless device to transmit an acknowledgement to the FTM response, where the acknowledgement is to be transmitted at a time t3; decoding an encrypted FTM frame from the responder; decrypting a media access control (MAC) portion of the encrypted FTM frame with the symmetric key, the decrypted FTM message including a time t1 when the FTM response was transmitted and a time t4 when the acknowledgement to the FTM response was received; and determining a distance of the wireless device from the responder based on time t1, time t2, time t3, and time t4.

In Example 19, the subject matter of Example 18 optionally includes the method further including: beginning to generate the symmetric key from the private encryption key of the wireless device and the public encryption key of the responder after time t2 and complete generating the symmetric key from the private encryption key of the wireless device and the public encryption key of the responder after the time t3.

Example 20 is an apparatus of a first wireless device including: memory; and processing circuitry coupled to the memory, the processing circuitry configured to: decode a fine time measurement (FTM) request including a public encryption key of a second wireless device; generate a symmetric key from a private encryption key of the first wireless device and the public encryption key of the second wireless device; encode a FTM response to the second wireless device, the FTM response including a public encryption key of the first wireless device; configure the wireless device to transmit the FTM response to the second wireless device at a time t1; decode an acknowledgement from the second wireless device of the FTM response, the acknowledgment to be received at a time t4; encrypt t1 and t4 with the symmetric encryption key; encode an encrypted FTM with encrypted t1 and t4; and configure the first wireless device to transmit the encrypted FTM to the second wireless device.

In Example 21, the subject matter of Example 20 optionally includes where the processing circuitry is configured to: generate the public encryption key of the first wireless device and the private encryption key of the first wireless device.

In Example 22, the subject matter of any one or more of Examples 20-21 optionally include where the processing circuitry is configured to: begin generating the symmetric key from the private encryption key of the first wireless device and the public encryption key of the second wireless device after the FTM request is decoded and complete generating the symmetric key from the private encryption key of the first wireless device and the public encryption key of the second wireless device before encrypting t1 and t4.

In Example 23, the subject matter of Example 22 optionally includes where the processing circuitry is configured to generate the symmetric key using an Elliptic Curve Diffie-Hellman or a public key crypto-system method.

In Example 24, the subject matter of any one or more of Examples 22-23 optionally include where the processing circuitry is configured to generate the symmetric key in a parallel process.

In Example 25, the subject matter of any one or more of Examples 20-24 optionally include transceiver circuitry coupled to the processing circuitry; and, one or more antennas coupled to the transceiver circuitry.

Example 26 is an apparatus of a wireless device including: means for encoding a fine time measurement (FTM) request including a public encryption key of the wireless device for transmission to a responder; means for decoding a FTM response from the responder, the FTM response including a public encryption key of the responder, where the FTM response is received at the wireless device at a time t2; means for generating a symmetric key from a private encryption key of the wireless device and the public encryption key of the responder; means for configuring the wireless device to transmit an acknowledgement to the FTM response, where the acknowledgement is to be transmitted at a time t3; means for decoding an encrypted FTM frame from the responder; means for decrypting a media access control (MAC) portion of the encrypted FTM frame with the symmetric key, the decrypted FTM message including a time t1 when the FTM response was transmitted and a time t4 when the acknowledgement to the FTM response was received; and means for determining a distance of the wireless device from the responder based on time t1, time t2, time t3, and time t4.

In Example 27, the subject matter of Example 26 optionally includes means for generating the public encryption key of the wireless device and the private encryption key.

In Example 28, the subject matter of any one or more of Examples 26-27 optionally include means for beginning generating the symmetric key from the private encryption key of the wireless device and the public encryption key of the responder after time t2 and complete generating the symmetric key from the private encryption key of the wireless device and the public encryption key of the responder after the time t3.

In Example 29, the subject matter of Example 28 optionally includes means for generating the symmetric key using an Elliptic Curve Diffie-Hellman method or a public key crypto-system.

In Example 30, the subject matter of any one or more of Examples 28-29 optionally include means for generating the symmetric key in a parallel process.

In Example 31, the subject matter of any one or more of Examples 26-30 optionally include means for configuring the wireless device to transmit an acknowledgement of the encrypted FTM message.

In Example 32, the subject matter of any one or more of Examples 26-31 optionally include means for performing a second FTM measurement with the responder using the symmetric key.

In Example 33, the subject matter of any one or more of Examples 26-32 optionally include means for configuring the wireless device to transmit the FTM request to the responder in accordance with one or both of orthogonal frequency division multiple-access (OFDMA) and multiple-user multiple-input and multiple-output (MU-MIMO).

In Example 34, the subject matter of any one or more of Examples 26-33 optionally include means for decoding the FTM response from the responder, where the public key of the responder is a part of a subelement, the subelement including an subelement identification, a length, and the public key, where the subelement identification identifies the subelement as a public key subelement.

In Example 35, the subject matter of any one or more of Examples 26-34 optionally include means for encoding the FTM request including a subelement, the subelement including a subelement identification, a length, and the public key of the wireless device, where the subelement identification identifies the subelement as a public key subelement.

In Example 36, the subject matter of any one or more of Examples 26-35 optionally include means for decoding the encrypted FTM frame from the responder, where a protected frame bit of a frame control field indicates the MAC portion of the encrypted FTM frame is encrypted.

In Example 37, the subject matter of any one or more of Examples 26-36 optionally include where the wireless device and the one or more stations are each one from the following group: an Institute of Electrical and Electronic Engineers (IEEE) 802.11ax access point, an IEEE 802.11ax station, an IEEE 802.11mc station, an IEEE 802.11mc access point, an IEEE 802.11 station, and an IEEE 802.11 access point.

In Example 38, the subject matter of any one or more of Examples 26-37 optionally include means for processing radio waves.

In Example 39, the subject matter of Example 38 optionally includes means for transmitting and receiving radio waves.

Example 40 is a non-transitory computer-readable storage medium that stores instructions for execution by one or more processors, the instructions to configure the one or more processors to cause an apparatus of a wireless device to: decode a fine time measurement (FTM) request including a public encryption key of a second wireless device; generate a symmetric key from a private encryption key of the first wireless device and the public encryption key of the second wireless device; encode a FTM response to the second wireless device, the FTM response including a public encryption key of the first wireless device; configure the wireless device to transmit the FTM response to the second wireless device at a time t1; decode an acknowledgement from the second wireless device of the FTM response, the acknowledgment to be received at a time t4; encrypt t1 and t4 with the symmetric encryption key; encode an encrypted FTM with encrypted t1 and t4; and configure the first wireless device to transmit the encrypted FTM to the second wireless device.

In Example 41, the subject matter of Example 40 optionally includes the instructions to further configure the one or more processors to cause the apparatus to: generate the public encryption key of the first wireless device and the private encryption key of the first wireless device.

In Example 42, the subject matter of any one or more of Examples 40-41 optionally include the instructions to further configure the one or more processors to cause the apparatus to: begin generating the symmetric key from the private encryption key of the first wireless device and the public encryption key of the second wireless device after the FTM request is decoded and complete generating the symmetric key from the private encryption key of the first wireless device and the public encryption key of the second wireless device before encrypting t1 and t4.

In Example 43, the subject matter of any one or more of Examples 40-42 optionally include the instructions to further configure the one or more processors to cause the apparatus to: generate the symmetric key using an Elliptic Curve Diffie-Hellman or a public key crypto-system method.

In Example 44, the subject matter of any one or more of Examples 40-43 optionally include the instructions to further configure the one or more processors to cause the apparatus to: generate the symmetric key in a parallel process.

Example 45 is a method of an apparatus of a wireless device to, the method including: decoding a fine time measurement (FTM) request including a public encryption key of a second wireless device; generating a symmetric key from a private encryption key of the first wireless device and the public encryption key of the second wireless device; encoding a FTM response to the second wireless device, the FTM response including a public encryption key of the first wireless device; configuring the wireless device to transmit the FTM response to the second wireless device at a time t1; decoding an acknowledgement from the second wireless device of the FTM response, the acknowledgment to be received at a time t4; encrypting t1 and t4 with the symmetric encryption key; encoding an encrypted FTM with encrypted t1 and t4; and configuring the first wireless device to transmit the encrypted FTM to the second wireless device.

In Example 46, the subject matter of Example 45 optionally includes the method further including: generating the public encryption key of the first wireless device and the private encryption key of the first wireless device.

In Example 47, the subject matter of any one or more of Examples 45-46 optionally include the method further including: beginning generating the symmetric key from the private encryption key of the first wireless device and the public encryption key of the second wireless device after the FTM request is decoded and complete generating the symmetric key from the private encryption key of the first wireless device and the public encryption key of the second wireless device before encrypting t1 and t4.

In Example 48, the subject matter of any one or more of Examples 45-47 optionally include the method further including: generating the symmetric key using an Elliptic Curve Diffie-Hellman or a public key crypto-system method.

In Example 49, the subject matter of any one or more of Examples 45-48 optionally include the method further including: generating the symmetric key in a parallel process.

Example 50 is an apparatus of a wireless device to, the apparatus including: means for decoding a fine time measurement (FTM) request including a public encryption key of a second wireless device; means for generating a symmetric key from a private encryption key of the first wireless device and the public encryption key of the second wireless device; means for encoding a FTM response to the second wireless device, the FTM response including a public encryption key of the first wireless device; means for configuring the wireless device to transmit the FTM response to the second wireless device at a time t1; means for decoding an acknowledgement from the second wireless device of the FTM response, the acknowledgment to be received at a time t4; means for encrypting t1 and t4 with the symmetric encryption key; means for encoding an encrypted FTM with encrypted t1 and t4: and means for configuring the first wireless device to transmit the encrypted FTM to the second wireless device.

In Example 51, the subject matter of Example 50 optionally includes the apparatus further including: means for generating the public encryption key of the first wireless device and the private encryption key of the first wireless device.

In Example 52, the subject matter of any one or more of Examples 50-51 optionally include the apparatus further including: means for beginning generating the symmetric key from the private encryption key of the first wireless device and the public encryption key of the second wireless device after the FTM request is decoded and complete generating the symmetric key from the private encryption key of the first wireless device and the public encryption key of the second wireless device before encrypting t1 and t4.

In Example 53, the subject matter of any one or more of Examples 50-52 optionally include the apparatus further including: means for generating the symmetric key using an Elliptic Curve Diffie-Hellman or a public key crypto-system method.

In Example 54, the subject matter of any one or more of Examples 50-53 optionally include the apparatus further including: means for generating the symmetric key in a parallel process.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a wireless device comprising: memory; and processing circuitry coupled to the memory, the processing circuitry configured to:
encode a fine time measurement (FTM) request comprising a public encryption key of the wireless device for transmission to a responder;
decode a FTM response from the responder, the FTM response comprising a public encryption key of the responder, wherein the FTM response is received at the wireless device at a time t2;
generate a symmetric key from a private encryption key of the wireless device and the public encryption key of the responder;
configure the wireless device to transmit an acknowledgement to the FTM response, wherein the acknowledgement is to be transmitted at a time t3;
decode an encrypted FTM frame from the responder;
decrypt a media access control (MAC) portion of the encrypted FTM frame with the symmetric key, the decrypted FTM message comprising a time t1 when the FTM response was transmitted and a time t4 when the acknowledgement to the FTM response was received; and
determine a distance of the wireless device from the responder based on time t1, time t2, time t3, and time t4.

2. The apparatus of claim 1, wherein the processing circuitry is configured to:
generate the public encryption key of the wireless device and the private encryption key.

3. The apparatus of claim 1, wherein the processing circuitry is configured to:
begin generating the symmetric key from the private encryption key of the wireless device and the public encryption key of the responder after time t2 and complete generating the symmetric key from the private encryption key of the wireless device and the public encryption key of the responder after the time t3.

4. The apparatus of claim 3, wherein the processing circuitry is configured to generate the symmetric key using an Elliptic Curve Diffie-Hellman method or a public key crypto-system.

5. The apparatus of claim 3, wherein the processing circuitry is configured to generate the symmetric key in a parallel process.

6. The apparatus of claim 1, wherein the processing circuitry is configured to:
configure the wireless device to transmit an acknowledgement of the encrypted FTM message.

7. The apparatus of claim 1, wherein the processing circuitry is configured to:
perform a second FTM measurement with the responder using the symmetric key.

8. The apparatus of claim 1, wherein the processing circuitry is further configured to:
configure the wireless device to transmit the FTM request to the responder in accordance with one or both of orthogonal frequency division multiple-access (OFDMA) and multiple-user multiple-input and multiple-output (MU-MIMO).

9. The apparatus of claim 1, wherein the processing circuitry is configured to:
decode the FTM response from the responder, wherein the public key of the responder is a part of a subelement, the subelement comprising a subelement identification, a length, and the public key, wherein the subelement identification identifies the subelement as a public key subelement.

10. The apparatus of claim 1, wherein the processing circuitry is configured to:
encode the FTM request comprising a subelement, the subelement comprising a subelement identification, a length, and the public key of the wireless device, wherein the subelement identification identifies the subelement as a public key subelement.

11. The apparatus of claim 1, wherein the processing circuitry is configured to:
decode the encrypted FTM frame from the responder, wherein a protected frame bit of a frame control field indicates the MAC portion of the encrypted FTM frame is encrypted.

12. The apparatus of claim 1, wherein the wireless device and the one or more stations are each one from the following group: an Institute of Electrical and Electronic Engineers (IEEE) 802.11ax access point, an IEEE 802.11 ax station, an IEEE 802.11mc station, an IEEE 802.11mc access point, an IEEE 802.11 station, and an IEEE 802.11 access point.

13. The apparatus of claim 1, further comprising transceiver circuitry coupled to the processing circuitry.

14. The apparatus of claim 13, further comprising one or more antennas coupled to the transceiver circuitry.

15. A non-transitory computer-readable storage medium that stores instructions for execution by one or more processors, the instructions to configure the one or more processors to cause an apparatus of a wireless device to:
encode a fine time measurement (FTM) request comprising a public encryption key of the wireless device for transmission to a responder;
decode a FTM response from the responder, the FTM response comprising a public encryption key of the responder, wherein the FTM response is received at the wireless device at a time t2;
generate a symmetric key from a private encryption key of the wireless device and the public encryption key of the responder;
configure the wireless device to transmit an acknowledgement to the FTM response, wherein the acknowledgement is to be transmitted at a time t3;
decode an encrypted FTM frame from the responder;
decrypt a media access control (MAC) portion of the encrypted FTM frame with the symmetric key, the decrypted FTM message comprising a time t1 when the FTM response was transmitted and a time t4 when the acknowledgement to the FTM response was received; and
determine a distance of the wireless device from the responder based on time t1, time t2, time t3, and time t4.

16. The non-transitory computer-readable storage medium of claim 15, the instructions to further configure the one or more processors to cause the apparatus to:
begin generating the symmetric key from the private encryption key of the wireless device and the public encryption key of the responder after time t2 and complete generating the symmetric key from the private encryption key of the wireless device and the public encryption key of the responder after the time t3.

17. The non-transitory computer-readable storage medium of claim 15, the instructions to further configure the one or more processors to cause the apparatus to:
generate the symmetric key using an Elliptic Curve Diffie-Hellman method or a public key crypto-system.

18. A method performed by an apparatus of a wireless device, the method comprising:
encoding a fine time measurement (FTM) request comprising a public encryption key of the wireless device for transmission to a responder;
decoding a FTM response from the responder, the FTM response comprising a public encryption key of the responder, wherein the FTM response is received at the wireless device at a time t2;
generating a symmetric key from a private encryption key of the wireless device and the public encryption key of the responder;
configuring the wireless device to transmit an acknowledgement to the FTM response, wherein the acknowledgement is to be transmitted at a time t3;
decoding an encrypted FTM frame from the responder;
decrypting a media access control (MAC) portion of the encrypted FTM frame with the symmetric key, the decrypted FTM message comprising a time t1 when the FTM response was transmitted and a time t4 when the acknowledgement to the FTM response was received; and
determining a distance of the wireless device from the responder based on time t1, time t2, time t3, and time t4.

19. The method of claim 18, the method further comprising:
beginning to generate the symmetric key from the private encryption key of the wireless device and the public encryption key of the responder after time t2 and complete generating the symmetric key from the private encryption key of the wireless device and the public encryption key of the responder after the time t3.

20. An apparatus of a first wireless device comprising: memory; and processing circuitry coupled to the memory, the processing circuitry configured to:
decode a fine time measurement (FTM) request comprising a public encryption key of a second wireless device;
generate a symmetric key from a private encryption key of the first wireless device and the public encryption key of the second wireless device;
encode a FTM response to the second wireless device, the FTM response comprising a public encryption key of the first wireless device;
configure the wireless device to transmit the FTM response to the second wireless device at a time t1;
decode an acknowledgement from the second wireless device of the FTM response, the acknowledgment to be received at a time t4;
encrypt t1 and t4 with the symmetric encryption key;
encode an encrypted FTM with encrypted t1 and t4; and
configure the first wireless device to transmit the encrypted FTM to the second wireless device.

21. The apparatus of claim 20, wherein the processing circuitry is configured to:
generate the public encryption key of the first wireless device and the private encryption key of the first wireless device.

22. The apparatus of claim 20, wherein the processing circuitry is configured to:
begin generating the symmetric key from the private encryption key of the first wireless device and the public encryption key of the second wireless device after the FTM request is decoded and complete generating the symmetric key from the private encryption key of the first wireless device and the public encryption key of the second wireless device before encrypting t1 and t4.

23. The apparatus of claim 22, wherein the processing circuitry is configured to generate the symmetric key using an Elliptic Curve Diffie-Hellman or a public key crypto-system method.

24. The apparatus of claim 22, wherein the processing circuitry is configured to generate the symmetric key in a parallel process.

25. The apparatus of claim 20, further comprising transceiver circuitry coupled to the processing circuitry, and, one or more antennas coupled to the transceiver circuitry.
